(19) United States
(12) Patent Application Publication
(10) Pub. No.: US 2011/0145055 A1
(43) Pub. Date: Jun. 16, 2011

(54) BRANDED CONTENT LADEN COMMERCIAL PORTALS

(75) Inventor: TIMOTHY TOBIN, Leawood, KS (US)

(73) Assignee: INNERFUND, LTD., OVERLAND PARK, KS (US)

(21) Appl. No.: 12/637,867

(22) Filed: Dec. 15, 2009

(51) Int. Cl. G06Q 30/00; G06F 15/16

(52) U.S. Cl. 705/14.39; 705/1.1; 709/203

(57) ABSTRACT

In one embodiment, the present disclosure contemplates a computer system, which, upon being programmed, is configured to perform a method comprising identifying an entity associated with a user of a user computer connected to the computer system; and providing an Internet Portal to the user computer on behalf of the entity such that the entity appears to the user as the provider or primary benefactor of the Internet Portal. In another embodiment, the present disclosure contemplates a method which comprises contacting supporters and potential supporters of an entity, marketing the entity to the supporters and potential supporters as a provider or primary benefactor of an Internet Portal, and providing the Internet Portal on behalf of the entity to each user of the Internet Portal such that the entity appears to each user as the provider or primary benefactor of the Internet Portal.

### FIELD OF THE INVENTION

This invention generally pertains to Internet portals and, more particularly, to a system and method to provide free content laden Internet Portals using virtual Internet Portal Providers (IPPs).

### BACKGROUND OF THE INVENTION

The invention is particularly applicable to internet portals and will be described with particular reference thereto. However, it will be appreciated by those skilled in the art that the invention has broader applications and may also be adapted for use in software applications, kiosk systems, point of sale systems, telemarketing systems and the like.

There are a large number of commercial entities offering content laden Portals (e.g., portals offering free Co-branded content from providers of news, weather, sports, finance, hobbies, entertainment) to users (or Internet Portal users). These companies spend advertising dollars through various marketing channels to attract and maintain their users. However, this customary approach to marketing involves a significant expenditure of money and human resources to expand the IPP's user base and also to retain the existing users. Therefore, it is desirable to devise a scheme that allows the IPP to attract and keep more users while greatly reducing the funds needed for advertising, branding and promotion of IPP's Portals.

Accordingly, it has been considered desirable to develop a new and improved internet portal which would overcome the foregoing difficulties and others while providing better and more advantageous overall results.

### SUMMARY OF THE INVENTION

The present disclosure contemplates a method which comprises marketing an entity as an Internet Portal Provider (IPP) to users of IPP Portals. A Internet Portal is offered on behalf of the entity to the users such that the entity appears to the users as the provider or primary benefactor of the Internet Portal.

In one embodiment, the present invention is a computer system, which, upon being programmed, is configured to perform a method comprising identifying an entity associated with a user of a user computer connected to the computer system; and providing an Internet Portal to the user computer on behalf of the entity such that the entity appears to the user as the provider or primary benefactor of the Internet Portal.

In another embodiment, the present invention is a method which comprises contacting supporters of an entity, marketing the entity to the supporters as a provider or primary benefactor of an Internet Portal, and providing the Internet Portal on behalf of the entity to each user of the Internet Portal such that the entity appears to each user as the provider or primary benefactor of the Internet Portal.

A system and method according to the present disclosure allows an Internet Portal Provider (IPP) to attract and keep more users (while greatly reducing the funds needed for advertising, branding and promotion) by marketing an entity (e.g., a nonprofit organization) as the provider or primary benefactor of an Internet Portals and offering the Internet Portal on behalf of the entity such that the entity appears to the users as the provider or primary benefactor of the Internet Portal. The Internet Portal has “look and feel” of the entity while the IPP runs the hardware, software, and logistical support to provide the Internet Portal. Thus, the entity is not required to provide the Internet Portal. The users may be chosen from a group of supporters or potential supporters of the entity. The entity is thus represented as the “brand” or primary brand benefactor of the Internet Portal and the users may be encouraged to show their support to the entity through engagement/usage of the Internet Portal. A monetary “engagement incentive” may be offered to a user for each month of continued usage of the Internet Portal, and the user may be allowed to redirect the “engagement incentive”, on their behalf, to the entity as a show of the user's support to the entity and its activities, thereby providing an additional source of funding to the entity.

### BRIEF DESCRIPTION OF THE DRAWINGS

FIG. 1 is a block diagram illustrating an exemplary arrangement to implement the virtual Internet Portal provider scheme according to one embodiment of the present disclosure.

FIG. 2 depicts an exemplary flowchart showing a process flow for the virtual Internet Portal provider methodology according to one embodiment of the present disclosure.

### BRIEF DESCRIPTION OF A PRESENTLY PREFERRED AND VARIOUS ALTERNATIVE EMBODIMENTS OF THE INVENTION

Reference will now be made in detail to several embodiments of the present invention, examples of which are illustrated in the accompanying drawings. It is to be understood that the figures and descriptions of the present disclosure included herein illustrate and describe elements that are of particular relevance to the present disclosure, while eliminating, for the sake of clarity, other elements found in typical Internet-based systems. It is noted at the outset that the terms “connected”, “connecting,” “electrically connected,” etc., are used interchangeably herein to generally refer to the condition of being electrically connected.

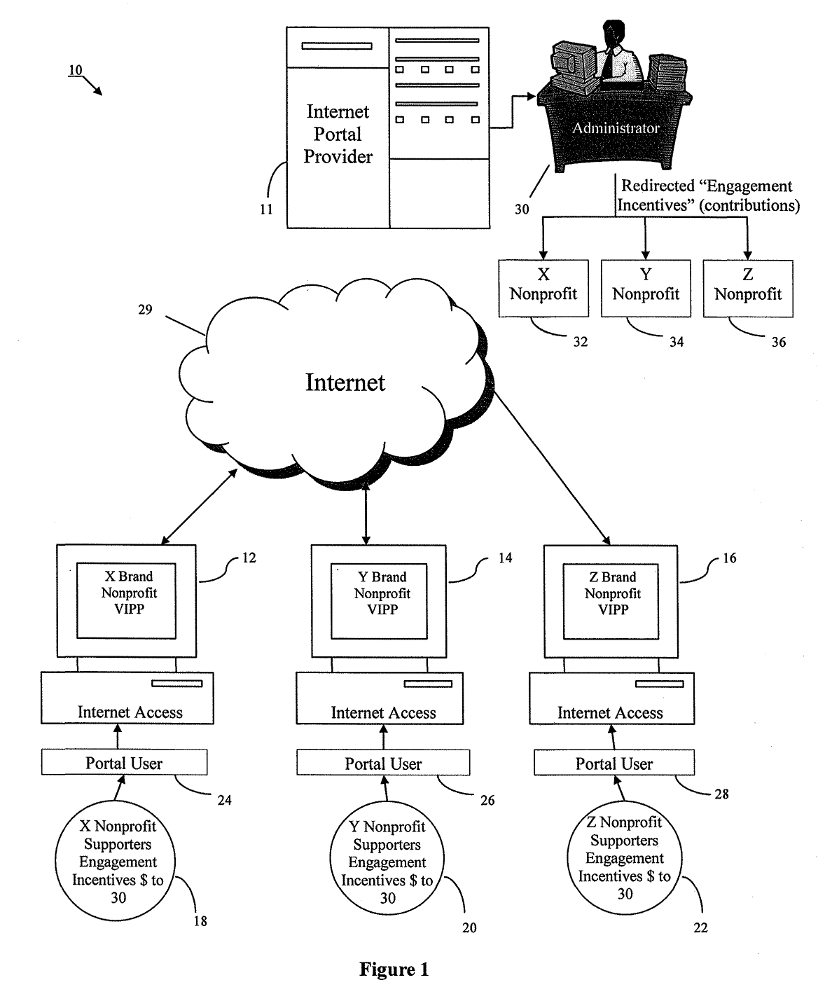

FIG. 1 is a block diagram illustrating an exemplary arrangement 10 to implement the virtual Internet Portal provider scheme according to one embodiment of the present invention. The arrangement 10 may include a server 11, which may be a server farm depending on the load to be handled, that is configured to provide a number of “nonprofit branded content laden for profit commercial portals” or individualized IPP platforms to various users of Internet Portals as discussed later herein below. As noted before, traditional providers (IPPs) of Internet Portals are generally required to expend large amount of advertising dollars (e.g., for mass mailings or television advertisements) to attract and retain users of their IPP Portals. On the other hand, according to one embodiment of the present disclosure, an IPP can attract and maintain users by utilizing and presenting the known “brand” of an entity as the IPP's own or primary benefactor to create a “brand facade.”

It is noted that the term “entity”, as used herein, refers to the following, a non-profit organization. Furthermore, the terms “Internet Portal” and “IPP Portal” are used interchangeably below to refer to one or more of the following types of Internet-based Portals (although the list presented here is not exhaustive): Internet access Portal (e.g., content laden website), website hosting, domain registration, online software downloads, online content delivery (e.g., news, weather, sports, entertainment, etc.), online user support, e-mail delivery (e.g., via the Internet), online marketing of various products and Portals, etc.

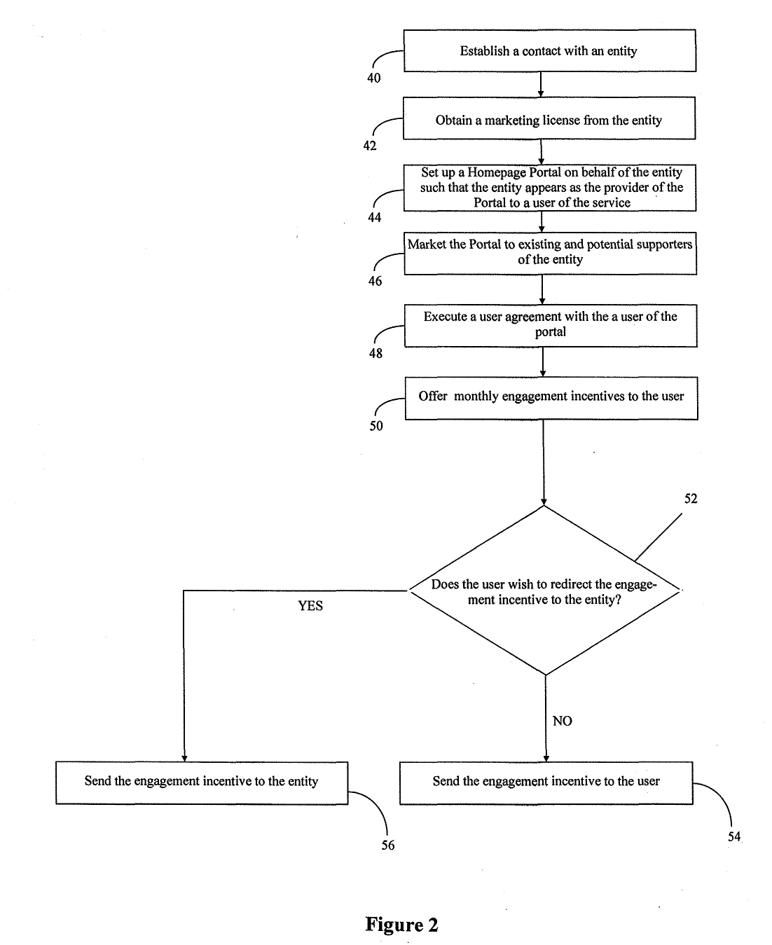

FIG. 2 depicts an exemplary flowchart showing a process flow for the virtual Internet Portal provider methodology according to one embodiment of the present invention. In the following discussion, the arrangement 10 in FIG. 1 is described with reference to the flowchart in FIG. 2. Initially, at block 40 in FIG. 2, a traditional Internet Portal provider (IPP) that is desirous of expanding its user base according to the methodology of the present disclosure may establish a contact with the entity (e.g., a non-profit organization), for example, through a marketing inquiry initiated by the IPP or in response to a similar inquiry from the entity. During marketing negotiations, the IPP may obtain a license or permission by the entity to use the name or “brand equity” or “goodwill” of the entity to market various Portals of the IPP to a target audience comprising of specific followers, supporters or well-wishers of the entity, block 42. After receiving the license or needed approval from the entity, the IPP may setup an Internet Portal platform on behalf of the entity to be marketed to the target audience in a manner such that the entity appears as the provider of the Internet Portal to a user/user of the Portal, block. Thus, the entity may function as a “virtual” IPP even though all the hardware, software, and logistics involved in offering the IPP Portals on behalf of the entity may be handled “behind the scenes” by the commercial IPP that approached the entity for the rights to use the entity's “brand equity” or “goodwill” to obtain users.

Specifically, the IPP may execute a licensing agreement, preferably for no money, with certain entities (e.g., non-profits) that allows the IPP to use the respective entity's brand as the identity of the provider of Internet Portals to be marketed to the entity's supporters and potential supporters. The IPP may then commence marketing of its Internet-related Portals to existing and potential supporters of the entity, block 46. In FIG. 1, three sets of supporters for three separate entities X, Y, and Z are indicated by the reference numerals 18, 20, and 22, respectively. The IPP may obtain the supporter list from the corresponding entity (preferably without a fee) and may contact those supporters (current or potential) from the list who are not presently users of IPP's Internet Portal. These potential users or clients may be contacted via telephone calls, targeted postal mailings, e-mails, etc.

The licensed use of an entity's brand for the IPP's Internet Portal results in creation of a “brand façade,” wherein the name, logo, and entire “look” (e.g., in traditional advertisements or literature) associated with the entity are presented or represented through all phases, from marketing to potential users, to logon to URL (Uniform Resource Locator), homepage (website and portal), e-mail branding, instant message branding, personal website branding, billing for Portals, etc. In other words, for all intents and purposes, the IPP projects the “look and feel” of the entity (e.g., a non-profit organization, a credit union, etc.) while the IPP runs the entire structure underneath or behind that “façade.” For example, the IPP may provide the logistics and support for such Portals as user sign-up, billing, user support, e-mail account set-up and maintenance, all branding for marketing, and content delivery (e.g., news, weather, sports, entertainment, etc.). The entity may not be required to provide any hardware, software, or logistical support to run the operations for the entity-specific Internet Portal.

In FIG. 1, the server 11 is shown to provide the Internet Portal to user computers 12, 14, and 16 via respective connections through the Internet 29. Thus, as illustrated in FIG. 1, when Internet users 24, 26, 28 access the Internet 29 through the users' computer 12, 14, and 16, respectively, the computers may project the “look and feel” of the entity supported by the corresponding user. For example, if the IPP's Virtual Internet Portal Partner (VIPP) is an X non-profit organization, then an Internet user 24 supporting the X nonprofit may see the X nonprofit's name, logo, and other familiar indicia as the Internet homepage for that user. Similar entity-specific homepages for Y and Z nonprofits may also appear for the users 26 and 28, respectively, as shown in FIG. 1. The server 11 may be configured to store and transmit the entity-specific web pages to respective users based on the user's information contained in the user agreement executed by the user. For example, during marketing of entity-specific Internet Portal to that entity's supporters, the IPP may include an entity-specific reference code in each marketing material sent to the supporters of a specific entity. The reference code may be required by the user to sign-up for the Internet Portal. In that manner, the IPP may identify the set of entity-specific web pages and marketing materials preferably stored in the server 11 to be sent to the user's computer for presentation to the user when the user signs up for the Internet Portal (e.g., login with username and password) and commences browsing of various sections or web links on the entity-specific homepage presented on the user's computer.

As noted above, each user from the entity-specific marketing by the IPP may be required to execute a user agreement with the IPP, block 48. The user agreement may allow the user to receive a monthly “engagement incentive” (from the advertising and search revenue paid to the IPP) for each month the user remains a user of the IPP's Internet Portal, block 50. The “engagement incentive” may be variable based on the total monthly engagements (e.g. advertising views and search queries of the user). Other suitable arrangements for “engagement incentive” awards may be devised as is known in the art. In the user agreement, the user may be given an option to either redirect the “engagement incentive” each month to the IPP's Virtual Internet Portal Partner (VIPP) (i.e., the entity whose “brand name” is marketed to the user by the IPP) or to request that the “engagement incentive” be sent to the user each month. The “engagement incentive” may be sent as a check. In one embodiment, the user agreement may provide “engagement incentive” accumulation for a specific time (e.g., three months) before the “engagement incentive” is mailed to the client. Various other “engagement incentive” delivery arrangements may be devised as is known in the art.

The “engagement incentive” preference indicated by the user may be stored in the central server 11 and monitored by an administrator 30 for the IPP. Alternatively, the server 11 may be programmed to automatically report the “engagement incentive” preference to the administrator 30 whenever a new user signs-up for the Internet Portal. If the user has indicated to redirect the “engagement incentive” to the entity supported by the user (block 52 in FIG. 2), then the administrator 30 may perform appropriate system programming (to configure the server 11 or other relevant processing computer (not shown)) so that the accrued monthly “engagement incentives” are automatically issued to the respective entities (e.g., the X, Y, and Z non-profits as indicated at blocks 32, 34, and 36, respectively, in FIG. 1) as indicated at block 56 in FIG. 2. The administrator 30 may program the system in such a manner that all “engagement incentives” from various users be redirected to a specific entity (e.g., the X non-profit) may be accumulated for each user supporting that entity and the total amount may be sent to the entity rather than separate “engagement incentives” containing user-specific amounts. On the other hand, if the user does not wish to redirect the user-specific “engagement incentive” to the user's entity of choice, the “engagement incentive”, in that case, may be sent to the user, block 54, in one of the manners discussed hereinbefore and as shown at blocks 32, 34, and 36. Thus, although the “engagement incentives” collected from an entity's supporters (who happen to be the users of the entity-specific Internet Portal provided by the administrator 30 through the server 11) are paid to the Portal administrator 30 (as indicated at 18, 20, and 22 in FIG. 1), the “engagement incentives” from those fees may be distributed to the user's entity of choice as discussed here.

As noted before, the server 11 may contain a number of servers, a server farm, to cope with increasing user load or to provide an entity-specific, dedicated server for each group of entity-specific users. All of the computers served by the server 11 may be linked to the server 11 via the Internet 29. Thus, as illustrated in FIG. 1, each user's web browsing experience may be “logged” or “recorded” in the server 11 through the Internet-based connection to the user's computer 12, 14, 16 and monitored by the administrator 30 or a group of administrators to determine what type of user- and entity-specific marketing be targeted to the user. In the embodiment of FIG. 1, the three computers 12, 14, and 16 are shown linked to the same server 11 via the Internet 29, but the server 11 may be configured to deliver different entity-specific web pages on respective user's computer. In this embodiment, the server 11 may associate each user's computer ID (e.g., an IP (Internet Protocol) address) with the specific entity the user supports, thereby linking entity-specific material preferably stored on the server 11 to its correct receiving terminal/computer.

The above described arrangement allows an IPP to attract and maintain users by utilizing and presenting the known “brand” of an entity (e.g., a nonprofit) as the provider or primary benefactor of the Internet Portal. Instead of spending the customary advertising dollars to attract users, the IPP may “borrow” the “brand equity” in an existing entity to attract and maintain users. It also allows the IPP a flexibility to show a multitude of fronts or brands, thereby giving the IPP the power of presenting not just one known brand, but many brands. On the other hand, the virtual Internet Portal provider arrangement according to the present disclosure allows an entity to utilize their brand equity in a more effective way (higher number of impressions, attract and retain new supporters, increased traffic to their website and increased funding) on the Internet. For example, in case of a nonprofit organization, such an arrangement allows the nonprofit to educate the public about its cause, obtain increased involvement and participation from targeted audiences, develop new volunteers and leaders to advertise and promote the nonprofit's work, etc. In case of a for-profit entity, advertising with the virtual Internet Portal provider arrangement may increase brand equity and organizational identity, more product distribution power, and may allow access to new users and current employees. Through such virtual IPP arrangement according to the present disclosure, the advertising for-profit entity may receive increased user loyalty, sales, improved employee morale and relations, enhanced corporate image, positive media attention, and a socially responsible reputation.

Under the arrangement 10 discussed hereinbefore, a nonprofit's supporters including its employee base, for example, may recognize the “brand” of their Internet Portal provider and wish to support it through, for example, redirecting their “engagement incentives.” The entity's (or Virtual Internet Portal Partner's) motivation to participate in such delivery of Internet Portal using the entity as a virtual Internet Portal provider may be secured by enlisting the entity's supporters or potential supporters to sign up for the Internet Portal that appears to be offered by the entity and that has a “licensed look” providing legitimacy and credibility to the IPP's marketing efforts. Thus, even though a user may realize that the entity supported by the user is not the actual IPP of the Internet Portal in terms of hardware, software, and logistical support required to offer and maintain the Portal, the user may still continue to subscribe to the Portal because of the “entity-sponsored” nature of the Portal and because of the credibility resulting from the familiar, entity-specific “look and feel” the user receives when accessing the entity-specific homepage on the Internet.

As discussed hereinbefore, the methodology according to the present disclosure may use three specific processes in unison: (1) the presentation of multiple entities as Internet Portal Provider brands, (2) “engagement incentives” to the users from the “real” or actual Internet Portal Provider, and (3) funding to the entity through redirected “engagement incentives” from the users. In case of a nonprofit, the “engagement incentives” may be key to compensating the nonprofit for increased utilization of its “brand” without requiring the nonprofit to directly participate in a for-profit venture. The user may realize that the nonprofit's appearance as its IPP is only a façade, but may want that façade in order to show the user's support and respect for the nonprofit mission. The nonprofit-branded Internet Portal according to one embodiment of the present disclosure may thus assist the commercial IPP to expand its user base while greatly reducing the funds needed for advertising, branding, and promotion of its Internet Portals had the IPP decided to market the Portals in the traditional manner.

The foregoing describes a system and method that allows an Internet Portal Provider (IPP) to attract and keep more users while greatly reducing the finds needed for advertising, branding and promotion by marketing an entity (e.g., a nonprofit organization) as the provider or primary benefactor of an Internet Portals and offering the Internet Portal on behalf of the entity such that the entity appears to the users as the provider or primary benefactor of the Internet Portal. The Internet Portal has the “look and feel” of the entity while the IPP runs the hardware, software, and logistical support to provide the Internet Portal. Thus, the entity is not required to provide the Internet Portal. The users may be chosen from a group of supporters of, or past or potential donors to, the entity. The entity is thus represented as the “brand” of the Internet Portal and the users may be encouraged to show their support to the entity through usage/engagement with the Internet Portal. A monetary “engagement incentive” may be offered to a user for each month of continued usage to the Internet Portal, and the user may be allowed to redirect the “engagement incentive” to the entity as a show of the user's support to the entity and its activities, thereby providing an additional source of funding to the entity.

While a presently preferred and various alternative embodiments of the present invention have been described in sufficient detail above to enable a person skilled in the relevant art to make and use the same it should be apparent that various other adaptations and modifications can be envisioned by those persons skilled in such art without departing from either the spirit of the invention or the scope of the appended claims.

What is claimed:

1. A method of attracting and keeping at least one user, said method comprising the steps of: marketing an entity as an Internet Portal Provider to said at least one user; and offering an Internet Portal on behalf of said entity to said at least one user such that said entity appears to said at least one user to be a provider of said Internet Portal or a primary benefactor of said Internet Portal.

2. The method of claim 1, further comprising the step of: establishing a marketing association with said entity.

3. The method of claim 2, wherein said establishing comprises licensing said entity's trademarks and logos to said Internet Portal Provider.

4. The method of claim 1, wherein said at least one user comprises at least one past or potential donor of said entity.

5. The method of claim 1, further comprising the steps of: offering a monetary engagement incentive to each user of said Internet Portal; and allowing said at least one user to select at least one of the following as a recipient of said engagement incentive: said user, and said entity.

6. The method of claim 5, further comprising the steps of: executing a user agreement with each said at least one user of said Internet Portal; and allowing said at least one user to select said recipient as part of said user agreement.

7. The method of claim 5, further comprising the step of: sending said monetary engagement incentive to said recipient.

8. The method of claim 1, wherein said entity comprises a non-profit entity.

9. A computer system, which, upon being programmed, is configured to perform a method comprising the steps of: identifying an entity associated with a user of a computer connected to said computer system; and providing an Internet Portal to said user of said computer on behalf of said entity such that said entity appears to said user as a provider of said Internet Portal or a primary benefactor of said Internet Portal.

10. The computer system of claim 9, which, upon being programmed, is configured to perform a method further comprising the steps of: presenting a user agreement for said Internet Portal to said user via said computer, wherein said user agreement comprises an offer of monetary engagement incentive to said user for using said Internet Portal; allowing said user to electronically execute said user agreement and to select in said user agreement at least one of the following as a recipient of said engagement incentive: said user, and said entity; and storing said user agreement as executed by said user.

11. The computer system of claim 10, which, upon being programmed, is configured to perform a method further comprising the steps of: sending said engagement incentive to said recipient; and alerting an administrator of said computer system to send said engagement incentive to said recipient.

12. A method of attracting and keeping at least one user, said method comprising the steps of: contacting at least one supporter of an entity; marketing said entity to said at least one supporter as a provider of an Internet Portal; and providing said Internet Portal on behalf of said entity to each user of said Internet Portal such that said entity appears to each said user as the provider of said Internet Portal or a primary benefactor of said Internet Portal.

13. The method of claim 12, wherein said marketing comprises: obtaining permission from said entity to market said entity to supporters thereof.

14. The method of claim 12, further comprising the steps of: offering an incentive to each user for continued engagement of said Internet Portal; allowing said user to redirect said incentive to said entity; and sending said incentive to said entity as per instructions from said user.

15. The method of claim 14, wherein said incentive is in the form of a monetary engagement incentive.

16. The method of claim 12, wherein said entity includes non-profit entities.
